(19) United States
(12) Patent Application Publication
(10) Pub. No.: US 2023/0400804 A1
(43) Pub. Date: Dec. 14, 2023

(54) IMAGE FORMING APPARATUS THAT FORMS IMAGE ON SHEET USING TONE CORRECTION CONDITION CORRESPONDING TO PROCESS SPEED

(71) Applicant: CANON KABUSHIKI KAISHA, Tokyo (JP)

(72) Inventors: Tatsuomi MURAYAMA, Chiba (JP); Tadashi FUKUDA, Tokyo (JP); Akihito YOKOTE, Chiba (JP)

(21) Appl. No.: 18/326,201

(22) Filed: May 31, 2023

(30) Foreign Application Priority Data
Jun. 8, 2022 (JP) 2022-093096

(51) Int. Cl. G03G 15/00

(52) U.S. Cl. CPC G03G 15/5025

(57) ABSTRACT

An image forming apparatus includes a storage unit configured to store first conversion information for converting a density of an image formed on an image carrier at a process speed into a density at another process speed among a plurality of process speeds; and a control unit configured to form a plurality of first patch images of different densities on the image carrier, with respect to each of the plurality of process speeds, determine respective densities of the plurality of first patch images based on a process speed at the time of formation of each of the plurality of first patch images and the first conversion information, and generate pieces of the tone correction condition that respectively correspond to the plurality of process speeds.

### BACKGROUND OF THE INVENTION

### Field of the Invention

The present disclosure relates to a tone correction control on an image forming apparatus.

### Description of the Related Art

An image forming apparatus of an electrophotographic method performs tone correction control in order to maintain the quality of an image to be formed. In the tone correction control, the image forming apparatus forms, for example, a tone correction pattern for tone correction on a sheet or an intermediate transfer member, and optically reads this tone correction pattern. Then, the image forming apparatus generates or updates a tone correction condition for adjusting tones (image density) of an image formation, such as a tone correction table, based on the reading result of the tone correction pattern.

Japanese Patent Laid-Open No. 2014-107648 discloses a configuration that performs tone correction control by, while forming an image based on a print job, forming a tone correction pattern in an edge region of a sheet in which the image based on the print job is not formed. Furthermore, Japanese Patent Laid-Open No. 2001-109219 discloses a configuration that performs tone correction control by, while forming an image based on a print job, forming a tone correction pattern in a non-image region of an intermediate transfer member. Note that “a non-image region of an intermediate transfer member” (hereinafter, “a non-image region of an intermediate transfer member” is also simply referred to as “a non-image region”) is a region between regions in which an image based on a print job is formed on the intermediate transfer member. As the entire tone correction pattern cannot be formed in one non-image region, Japanese Patent Laid-Open No. 2001-109219 also discloses that one tone correction pattern is formed dispersedly in a plurality of non-image regions by dividing the tone correction pattern into a plurality of parts.

An image forming apparatus is configured to form an image on a variety of types of sheets, and controls a process speed (also referred to as an image forming speed) in accordance with a sheet on which an image is to be formed. Here, the process speed is, for example, a surface speed of an image carrier, or a rotation speed of another rotating member used in image formation. There is a possibility that tone characteristics of an image forming apparatus vary depending on the process speed. Therefore, in order to maintain the quality regardless of the process speed, it is necessary to execute the tone correction control for each process speed and generate tone correction tables (tone correction condition) for the respective process speeds. However, executing the tone correction control for each process speed extends a time period required for the tone correction control.

In view of this, Japanese Patent Laid-Open No. 2011-253067 discloses a configuration in which a tone correction table is generated by executing the tone correction control at a process speed that serves as a reference (a reference process speed), and in addition, tone correction tables for other process speeds are estimated and generated from this generated tone correction table.

For example, assume that a tone correction pattern is formed dispersedly in a plurality of non-image regions during the execution of a print job, and the tone correction control is performed using such a tone correction pattern, as with the configuration described in Japanese Patent Laid-Open No. 2001-109219. Further assume that, based on a tone correction table for a reference process speed obtained through the tone correction control, tone correction tables for other process speeds are generated, as with the configuration described in Japanese Patent Laid-Open No. 2011-253067. In this case, if the process speed is constant at the reference process speed during the execution of the tone correction control, the tone correction table for the reference process speed can be generated, and furthermore, tone correction tables for other process speeds can be generated based on the tone correction table for the reference process speed.

However, in a case where the process speed of a print job at the timing of the tone correction control is different from the reference process speed, the tone correction table for the reference process speed cannot be generated, and consequently, the tone correction tables for other process speeds cannot be generated, either. In this case, if the tone correction control is executed before the next print job is started for the purpose of updating a tone correction table, a time period in which image formation cannot be performed, that is to say, downtime, is extended.

### SUMMARY OF THE INVENTION

According to an aspect of the present disclosure, an image forming apparatus that forms an image on a sheet using a tone correction condition corresponding to a process speed, includes: an image forming unit configured to form an image on an image carrier; a first detection unit configured to detect a density of the image formed on the image carrier; a storage unit configured to store first conversion information for converting the density of the image formed on the image carrier by the image forming unit into a density at a process speed that is different from a process speed at the time of formation of the image among a plurality of process speeds; and a control unit configured to, while the image is formed on the sheet in accordance with a print job, form a plurality of first patch images of different densities on the image carrier by controlling the image forming unit, with respect to each of the plurality of process speeds, determine respective densities of the plurality of first patch images based on respective densities of the plurality of first patch images detected by the first detection unit, a process speed at the time of formation of each of the plurality of first patch images, and the first conversion information, and generate pieces of the tone correction condition that respectively correspond to the plurality of process speeds based on the respective densities of the plurality of first patch images that have been determined with respect to each of the plurality of process speeds.

Further features of the present invention will become apparent from the following description of exemplary embodiments with reference to the attached drawings.

### BRIEF DESCRIPTION OF THE DRAWINGS

FIG. 1 is a schematic cross-sectional diagram of an image forming apparatus according to an embodiment.

FIG. 2 is a configuration diagram of a density sensor according to an embodiment.

FIG. 3 is a functional block diagram of the image forming apparatus according to an embodiment.

FIG. 4 is a diagram for describing a tone correction table according to an embodiment.

FIG. 5 is a diagram for describing tone correction control according to an embodiment.

FIG. 6 is a flowchart of processing for generating a conversion table according to an embodiment.

FIG. 7 is a diagram for describing the processing for generating the conversion table according to an embodiment.

FIG. 8 is a diagram for describing the conversion table according to an embodiment.

FIG. 9 is a flowchart of the tone correction control according to an embodiment.

FIG. 10A and FIG. 10B are diagrams for describing the tone correction control according to an embodiment.

FIG. 11A and FIG. 11B are diagrams for describing downtime according to an embodiment.

FIG. 12 is a flowchart of processing of generating a conversion table according to an embodiment.

FIG. 13 is a diagram for describing the processing for generating the conversion table according to an embodiment.

FIG. 14 is a diagram for describing the conversion table according to an embodiment.

FIG. 15 is a flowchart of tone correction control according to an embodiment.

FIG. 16A and FIG. 16B are diagrams for describing the tone correction control according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

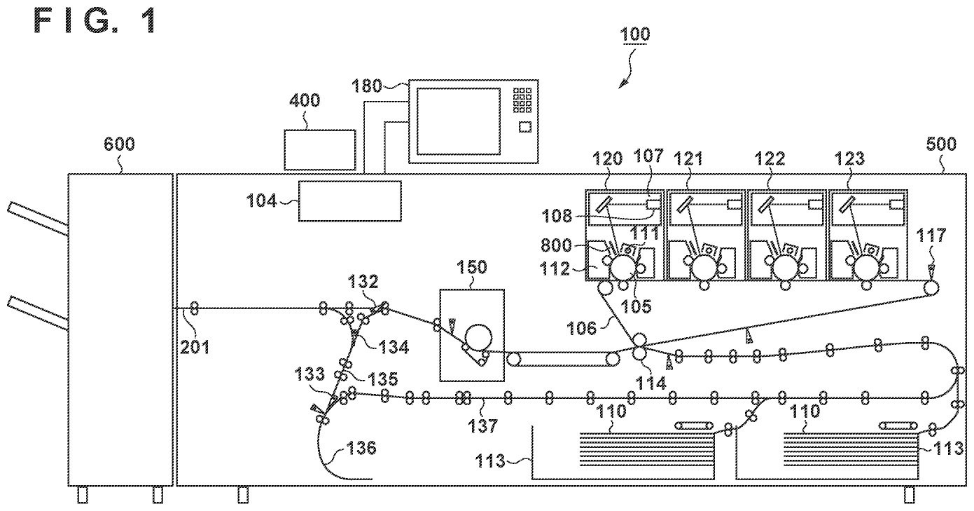

FIG. 1 is a schematic cross-sectional diagram of an image forming apparatus 100 according to the present embodiment. The image forming apparatus 100 includes a main body unit 500, a processing apparatus 600, a reading unit 400, and an operation unit 180. The reading unit 400 reads, for example, a surface of a document, and outputs image data, which is the reading result, to the main body unit 500. The operation unit 180 provides an interface for a user of the image forming apparatus 100. The user of the image forming apparatus 100 can determine the state of the image forming apparatus 100 based on information displayed on the operation unit 180. Furthermore, the user can control the image forming apparatus 100 via the operation unit 180 based on information displayed on the operation unit 180.

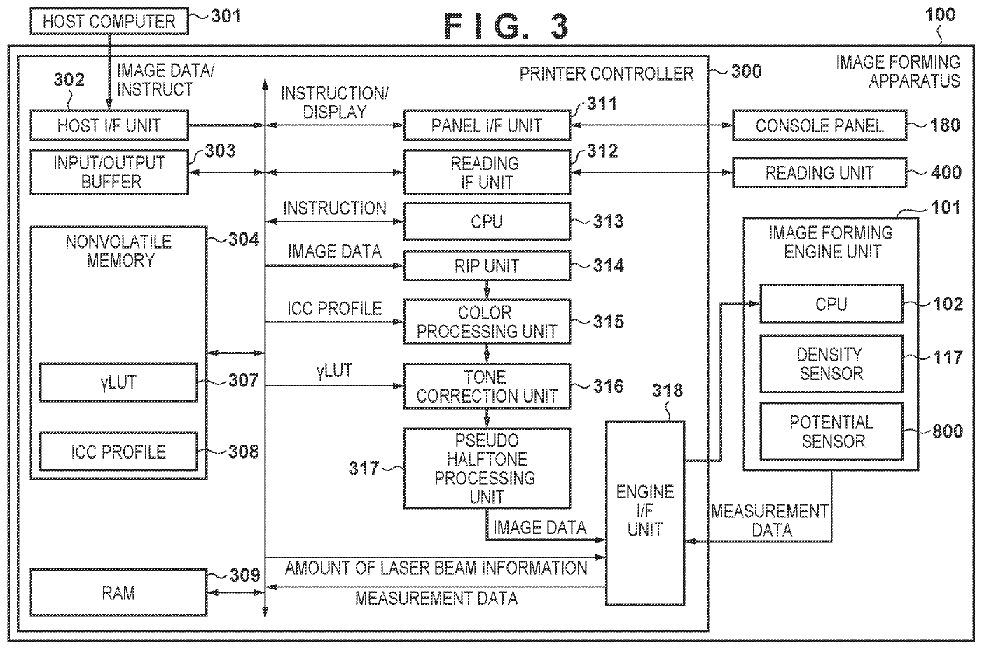

The main body unit 500 includes image forming units 120 to 123. Th image forming units 120 to 123 form toner images in yellow, cyan, magenta, and black, respectively, and transfer them to an intermediate transfer member 106, which is an image carrier. The configurations of the image forming units 120 to 123 are similar to one another, except for the colors of toner used therein. A photosensitive member 105, which is an image carrier, is driven to rotate in the counterclockwise direction of the figure at the time of image formation. A primary charger 111 charges the photosensitive member 105 that is driven to rotate. An exposure unit 107 exposes the photosensitive member 105 to light by controlling light emission of a light source 108 based on image data, and forms an electrostatic latent image on the photosensitive member 105. Note that the image data is image data based on the result of reading performed by the reading unit 400, or image data that the image forming apparatus 100 has received from a host computer 301 (see FIG. 3) via a network. A developer 112 forms a toner image on the photosensitive member 105 by developing the electrostatic latent image on the photosensitive member 105 using toner. As stated earlier, the toner images that have been formed on the respective photosensitive members 105 are transferred to the intermediate transfer member 106. Note that colors different from yellow, cyan, magenta, and black can be reproduced by transferring the toner images on the respective photosensitive members 105 to the intermediate transfer member 106 in such a manner that the toner images overlap one another. A potential detection unit 800 detects a potential on a surface of the photosensitive member 105.

The intermediate transfer member 106 is driven to rotate in the clockwise direction of the figure at the time of image formation. The rotation of the intermediate transfer member 106 causes the toner images on the intermediate transfer member 106 to be conveyed to a position opposing a transfer roller 114. The transfer roller 114 transfers the toner images on the intermediate transfer member 106 to a sheet 110 that has been conveyed from a cassette 113 to the position opposing the transfer roller 114. The sheet 110 on which the toner images have been transferred is conveyed to a fixing device 150. The fixing device 150 fixes the toner images on the sheet 110 by applying pressure and heat to the sheet 110.

In a case where an image is formed only on one surface of the sheet 110 and the sheet 110 is discharged with the surface on which the image has been formed facing up, the sheet 110 is conveyed to the processing apparatus 600 via a conveyance path 201 after the toner images have been fixed. In a case where an image is formed only on one surface of the sheet 110 and the sheet 110 is discharged with the surface on which the image has been formed facing down, the sheet 110 is first conveyed to a conveyance path 136 via a conveyance path 135 after the toner images have been fixed. Thereafter, the sheet 110 is conveyed to the conveyance path 201 via the conveyance path 135. In a case where an image is formed on both surfaces of the sheet 110, the sheet 110 is first conveyed to the conveyance path 136 via the conveyance path 135 after the toner images have been fixed. Subsequently, the sheet 110 is conveyed to the position opposing the transfer roller 114 again via a conveyance path 137, and an image is formed on the other surface. Thereafter, the sheet 110 is conveyed to the conveyance path 201 via the fixing device 150. Flappers 132 to 134 are provided to switch among the conveyance paths of the sheet. The processing apparatus 600 executes post-processing with respect to the sheet 110 on which the image(s) has been formed.

The main body unit 500 includes a control board storage unit 104, which stores an image forming engine unit 101 (FIG. 3) that controls the image forming apparatus 100, as well as a printer controller 300 (FIG. 3). Furthermore, a density sensor 117 that detects the tones (densities) of the toner images formed on the intermediate transfer member 106 is arranged at a position opposing the intermediate transfer member 106.

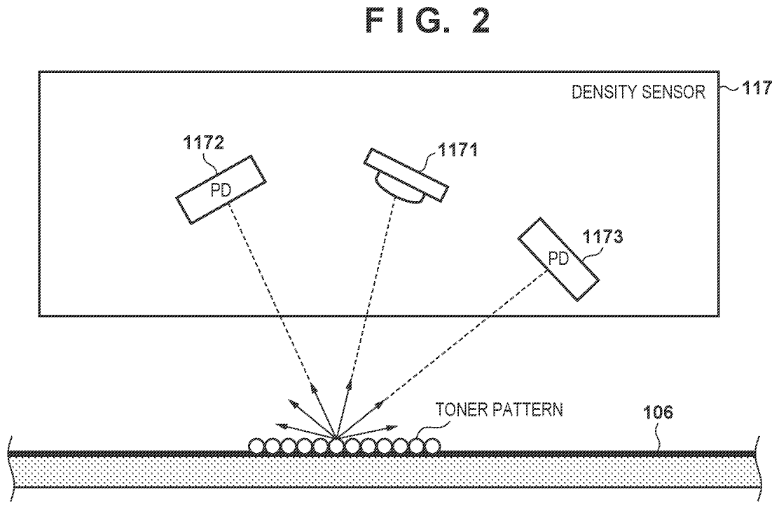

FIG. 2 is a schematic configuration diagram of the density sensor 117. An LED 1171, which is a light emitting element, emits light toward the intermediate transfer member 106. A photodiode (PD) 1172, which is a light receiving element, is disposed so as to receive specular reflection light from the intermediate transfer member 106 (or the toner images formed thereon) associated with the light emitted from the LED 1171. Furthermore, a PD 1173, which is a light receiving element, is disposed so as to receive diffuse reflection light from the intermediate transfer member 106 (or the toner images formed thereon) associated with the light emitted from the LED 1171, but not to receive the specular reflection light.

Regarding toner in black, the specular reflection light becomes less intense as the density increases; therefore, the density of the toner image in black can be detected based on the amount of the specular reflection light received by the PD 1172. Furthermore, regarding toner in yellow, cyan, or magenta (hereinafter, a chromatic color), the diffuse reflection light becomes more intense as the density increases; therefore, the density of the toner image in a chromatic color can be detected based on the amount of the diffuse reflection light received by the PD 1173. In the present embodiment, the density sensor 117 detects the densities of such toner images as tone correction patterns formed on the intermediate transfer member 106; however, the density sensor 117 may also be designed to detect the densities of toner images on the respective photosensitive members 105. Furthermore, in this case, the image forming apparatus 100 may be configured to transfer each photosensitive member 105 directly to a sheet.

FIG. 3 shows a control configuration of the image forming apparatus 100 according to the present embodiment. The image forming apparatus 100 is configured to be capable of communicating with the host computer 301 via a network and the like. A host OF unit 302 controls communication with the host computer 301. An input/output buffer 303 temporarily stores data that is transmitted to and received from the host computer 301. A CPU 313 controls the operations of the entirety of the printer controller 300. A nonvolatile memory 304 stores a control program executed by the CPU 313, and control data used in control performed by the CPU 313. A RAM 309 is used as a working memory for the CPU 313. A panel OF unit 311 is an interface with the operation unit 180, and a reading IF unit 312 is an interface with the reading unit 400.

A raster image processor (RIP) unit 314 generates bitmap image data based on an image object indicated by image data received from the host computer 301. A color processing unit 315 executes color conversion processing with respect to a bitmap image based on an ICC profile 308 stored in the nonvolatile memory 304. Atone correction unit 316 executes tone correction for each color based on γLUTs 307 corresponding to the respective colors, which are stored in the nonvolatile memory 304. The γLUTs 307 are tone correction tables. A pseudo halftone processing unit 317 executes pseudo halftone processing using a dither matrix, an error diffusion method, and the like. An engine OF unit 318 executes processing for communication with the image forming engine unit 101. For example, image data output from the pseudo halftone processing unit 317 is transmitted to the image forming engine unit 101 via the engine OF unit 318. A CPU 102 of the image forming engine unit 101 forms an image on a sheet 110 based on image data, as has been described using FIG. 1. Furthermore, the detection results performed by the density sensor 117 and the potential sensors 800 are output to the CPU 313 via the engine OF unit 318.

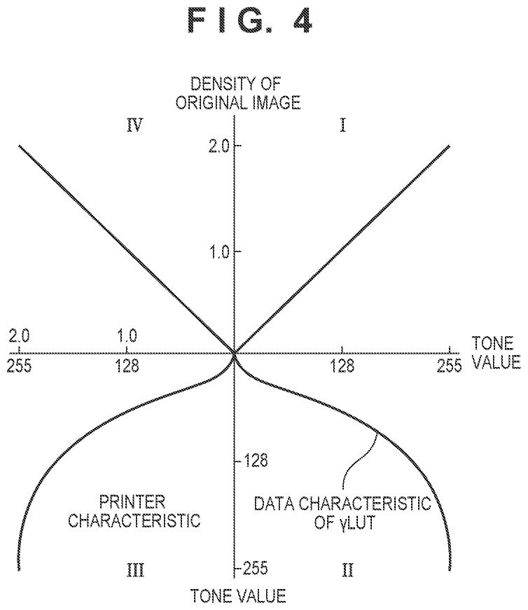

FIG. 4 is a diagram for describing a γLUT 307. In FIG. 4, quadrant I indicates a relationship between the density of an original image and an input tone value, and quadrant II indicates characteristics of conversion from an input tone value into an output tone value according to the γLUT 307. Furthermore, quadrant III indicates the density of an image that the image forming apparatus 100 forms on a sheet 110 based on an output tone value, that is to say, printer characteristics, and quadrant IV indicates a relationship between the density of an original image and the density of an output image. Note, it is assumed in FIG. 4 that a tone value is indicated using 8 bits, that is to say, 256 tones. The γLUT 307 compensates the printer characteristics of quadrant III. That is to say, as a result of converting an input tone value into an output tone value using the γLUT 307 and forming an image based on the output tone value, the density of the formed image corresponds to the input tone value.

In the present embodiment, the CPU 313 performs tone correction control using a non-image region of the intermediate transfer member 106, that is to say, a region between image regions in which toner images to be transferred to the sheet 110 are formed on the intermediate transfer member 106. FIG. 5 is a diagram for describing the tone correction control. A region between two image regions that neighbor each other in the sub scanning direction in FIG. 5 is a non-image region. Note that the sub scanning direction corresponds to the direction of movement of a surface of the intermediate transfer member 106 caused by the rotation of the intermediate transfer member 106. In the present embodiment, the density sensor 117 includes density sensors 117-Y, 117-M, 117-C, and 117-K that correspond to the respective colors. The density sensors 117-Y, 117-M, 117-C, and 117-K are provided at positions that are different from one another in the main scanning direction, which is perpendicular to the sub scanning direction. The density sensors 117-Y, 117-M, 117-C, and 117-K respectively detect yellow, magenta, cyan, and black tone correction patterns that have been formed inside the non-image region.

Each of the tone correction patterns for the respective colors includes a plurality of patch images with different tones. Each patch image has, for example, a shape of a square whose sides are each approximately 10 mm. As one example, the tone correction patterns for the respective colors include a total of 10 patch images with tone values of 0, 16, 32, 64, 86, 104, 128, 176, 224, and 255. In each non-image region, the number of patch images that can be formed in this non-image region are formed. For example, provided that only one patch image can be formed in one non-image region as shown in FIG. 5, the CPU 313 forms a total of 10 patch images that compose one tone correction pattern in a total of 10 non-image regions. Then, the CPU 313 executes processing for generating or updating the γLUTs 307 for the respective colors based on the result of detection of the total of 10 patch images that compose one tone correction pattern by the density sensor 117. Specifically, the CPU 313 determines the printer characteristics of FIG. 4 based on the densities of the total of 10 patch images measured by the density sensor 117. Then, the CPU 313 generates the γLUTs 307 and updates the γLUTs 307 stored in the nonvolatile memory 304 so as to compensate the determined printer characteristics.

As described above, the image forming apparatus 100 is configured to be capable of forming an image on a variety of types of sheets 110. Therefore, the image forming apparatus 100 controls the process speed (image forming speed) depending on the type of a sheet 110. The process speed (image forming speed) may be, for example, the rotation speed of the photosensitive members 105, the moving speed of the surface of the intermediate transfer member 106, or the conveyance speed of the sheet 110. By changing the process speed, the conveyance speed of paper that passes through the fixing device 150 can be changed, and the amount of heat applied to the sheet 110 per unit time can be made variable. For example, a sheet 110 with a first basis weight requires a large amount heat for fixing toner images compared to a sheet 110 with a second basis weight smaller than the first basis weight. Therefore, the image forming apparatus 100 makes the process speed for the sheet 110 with the first basis weight lower than the process speed for the sheet 110 with the second basis weight. Along with the change in the process speed, image forming conditions, such as a transfer voltage output from the transfer roller 114, are also changed. When the process speed and the image forming conditions have been changed in accordance with a sheet type, the printer characteristics of the image forming apparatus 100 (see FIG. 4) also change accordingly. Therefore, appropriate γLUTs 307 vary depending on the process speed.

For this reason, in the present embodiment, γLUTs 307 are generated and held for each process speed, and at the time of image formation, the tone correction unit 316 performs tone correction using the γLUTs 307 corresponding to the process speed in this image formation. The γLUTs 307 for a certain process speed are generated based on the detection result of tone correction patterns formed on the intermediate transfer member 106 at this process speed by the density sensor 117. Here, as stated earlier, in the present embodiment, the tone correction control is performed by forming patch images in a non-image region of the intermediate transfer member 106 when an image is formed based on a print job (hereinafter simply referred to as a job). If the γLUTs 307 for each process speed can be generated based on the detection result of the tone correction patterns formed at the process speed corresponding to the job by the density sensor 117, downtime for generating the γLUTs 307 corresponding to a process speed different from the job can be reduced. To this end, in the present embodiment, a conversion table, which is conversion information for converting the detection result (detected density) by the density sensor 117 among the plurality of process speeds, is generated and updated at a predetermined timing. Note that the conversion table is stored into the nonvolatile memory 304.

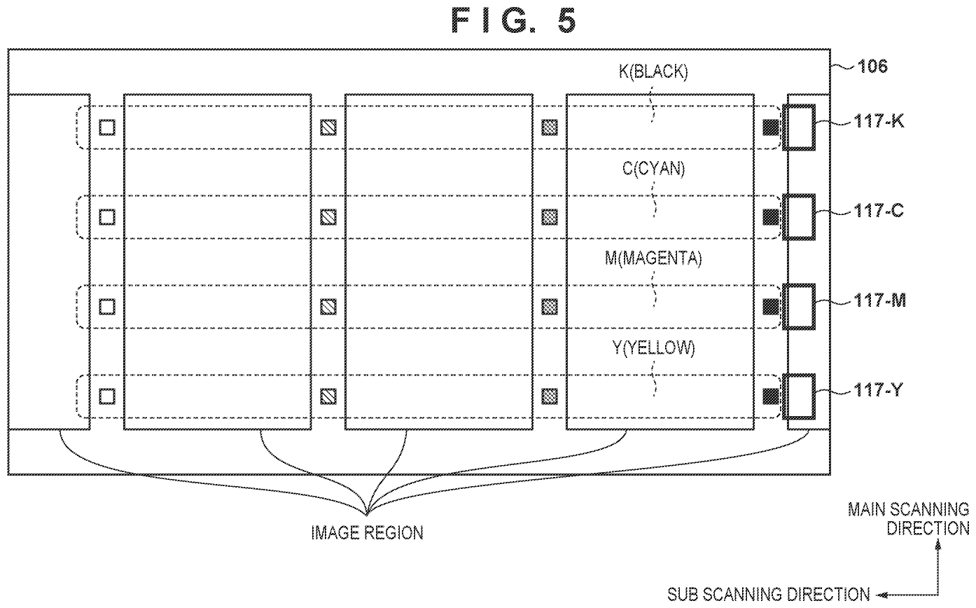

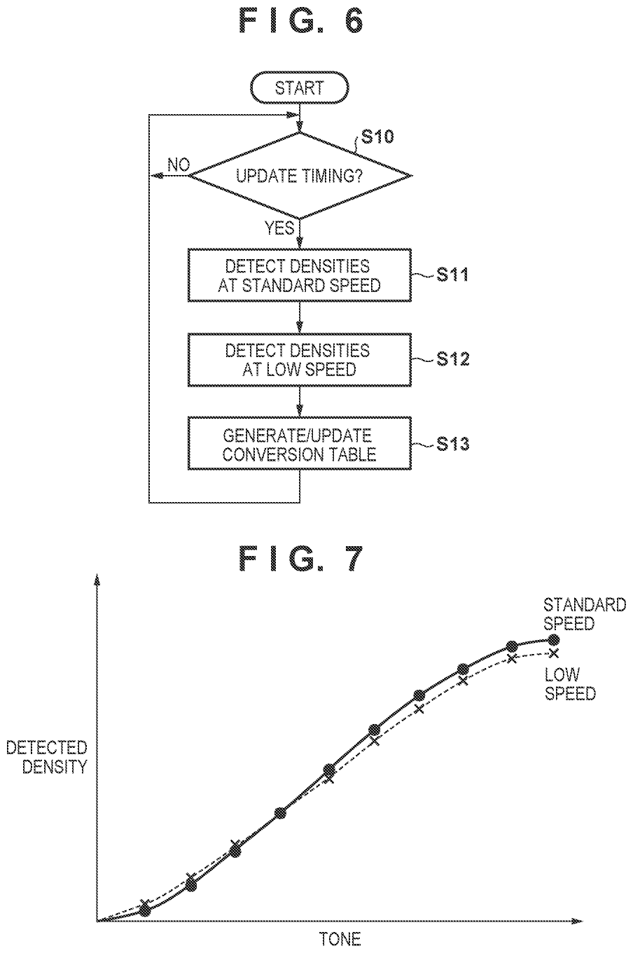

FIG. 6 is a flowchart of processing for generating or updating the conversion table. Note that it is assumed in the present embodiment that there are two process speeds, namely a “standard speed” and a “low speed”; however, the present embodiment is applicable also to an image forming apparatus that has three or more process speeds. In step S10, the CPU 313 waits until the arrival of an update timing for the conversion table. The update timing for the conversion table is, for example, when the power of the image forming apparatus 100 has been turned ON, when a certain time period has elapsed without performing image formation, a timing at which environmental conditions, such as the temperature and/or humidity, have fluctuated by an amount larger than a predetermined amount, or the like. Upon arrival of the update timing for the conversion table, the CPU 313 sets the process speed at the standard speed, forms a tone pattern on the intermediate transfer member 106, and detects the densities of the tone pattern using the density sensor 117 in step S11. Note that the tone pattern formed on the intermediate transfer member 106 includes a plurality of patch images with different tones. This tone pattern may be the same as, or may be different from, the tone correction patterns used in generating and updating the γLUTs 307. Note that the tone pattern being different from the tone correction patterns means that the number of patch images, the tone value of each patch image, and the like are different. In step S12, the CPU 313 sets the process speed at the low speed, forms the same tone pattern as in step S11 on the intermediate transfer member 106, and detects the densities of the tone pattern using the density sensor 117. The CPU 313 generates and updates a conversion table for converting the densities between the standard speed and the low speed based on the detection results of densities in steps S11 and S12 in step S13, and repeats processing from step S10.

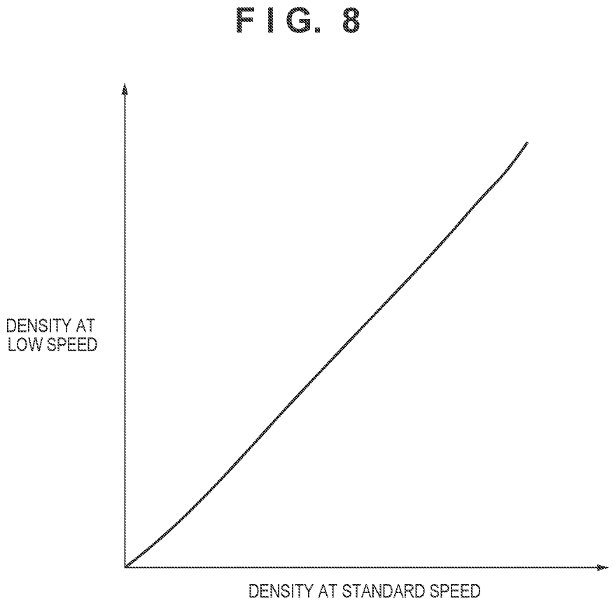

A solid line in FIG. 7 indicates an example of a relationship between the tone and the density detected in step S11, and a dash line in FIG. 7 indicates an example of a relationship between the tone and the density detected in step S12. FIG. 8 shows an example of the conversion table generated in step S13. The conversion table indicates a relationship between the density at the standard speed and the density at the low speed. Note that in a case where there are three or more process speeds, the conversion table is configured so as to enable density conversion between any two process speeds.

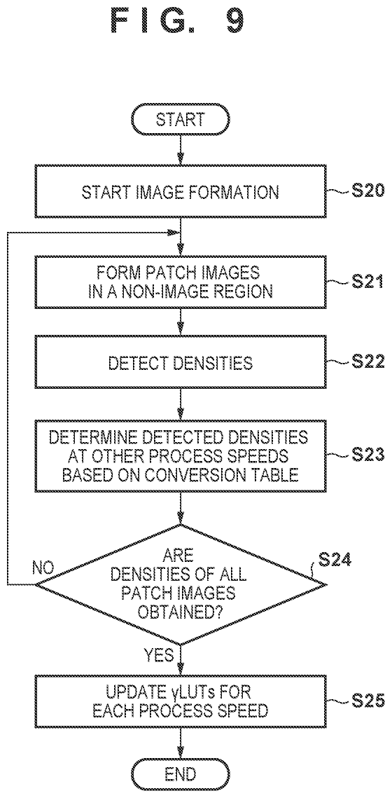

FIG. 9 is a flowchart of the tone correction control according to the present embodiment. Note that as stated earlier, the tone correction control according to the present embodiment is processing for generating and updating the γLUTs 307. The CPU 313 executes processing of FIG. 9 when, for example, a predetermined condition is satisfied. The predetermined condition is satisfied, for example, in a case where image formation based on the first job after the power of the image forming apparatus has been turned ON has been started, or in a case where the number of printed sheets has exceeded a predetermined number since processing of FIG. 9 was executed previously. In step S20, the CPU 313 starts image formation based on a job. In step S21, the CPU 313 forms patch images of tone correction patterns in a non-image region of the intermediate transfer member 106. Note that the number of the patch images formed in the non-image region has been decided on in advance based on the size of the non-image region. In step S22, the CPU 313 determines the densities of the patch images formed in step S21 based on the detection result by the density sensor 117. In step S23, based on the process speed at the time of formation of the patch images in step S21, the CPU 313 determines the densities of the patch images at another process speed using the conversion table.

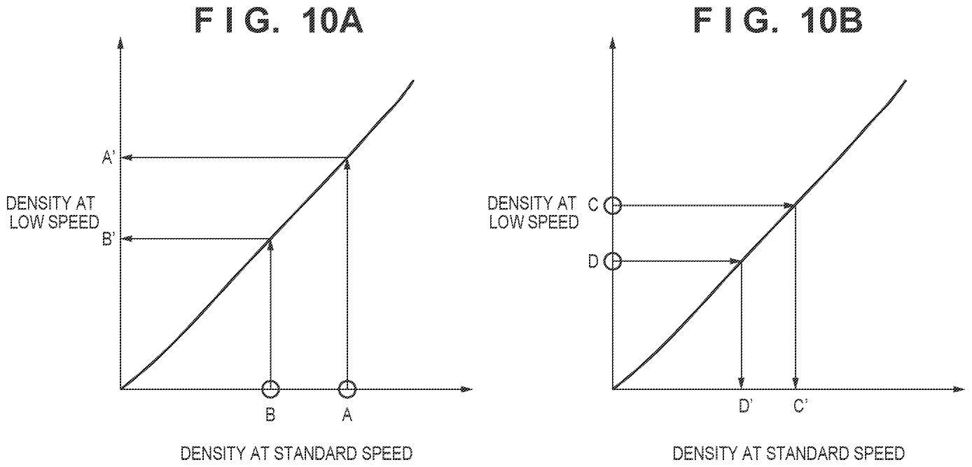

For example, as shown in FIG. 10A, assume that two patch images are formed at the standard speed in step S21, and A and B have been detected as the densities of the two patch images at the standard speed in step S22. In this case, in step S23, the CPU 313 determines that the densities at the low speed are A′ and B′ in accordance with the conversion table, as shown in FIG. 10A. On the other hand, as shown in FIG. 10B, assume that two patch images are formed at the low speed in step S21, and C and D have been detected as the densities of the two patch images at the low speed in step S22. In this case, in step S23, the CPU 313 determines that the densities at the standard speed are C′ and D′ in accordance with the conversion table, as shown in FIG. 10B. In this way, the CPU 313 obtains the densities of the patch images for each process speed in step S23, regardless of the process speed in step S21.

Returning to FIG. 9, in step S24, the CPU 313 determines whether the densities of the patch images of 10 tones included in the tone correction pattern have been obtained for each color. In a case where the densities of the patch images of 10 tones included in the tone correction pattern have not been obtained for each color, the CPU 313 repeats processing from step S21. In a case where the densities of the patch images of 10 tones included in the tone correction pattern have been obtained for each color, the CPU 313 generates γLUTs 307 for each process speed and stores them into the nonvolatile memory 304 in step S25. Note that although not shown in FIG. 9, it is permissible to adopt a configuration in which only the tone correction control is continued as is in a case where the image formation based on the job has ended before completion of formation of the patch images of 10 tones included in the tone correction patterns for each color. That is to say, the tone correction patterns are generated by forming the remaining patch images at the process speed of the job that has ended. Furthermore, it is permissible to adopt a configuration in which, in a case where the image formation based on the job has ended before completion of formation of the patch images of 10 tones included in the tone correction pattern for each color, the densities of the patch images that have been measured up until that point are stored into, for example, the RAM 309. In this case, at the time of image formation based on the next job, the remaining patch images are formed and the densities are measured; once the densities of the patch images of 10 tones included in the tone correction pattern have been obtained for each color, processing of step S25 is executed. Also, it is assumed in the present embodiment that processing of FIG. 9 is executed in a case where image formation based on the first job after the power of the image forming apparatus has been turned ON has been started, or in a case where the number of printed sheets has exceeded a predetermined number since processing of FIG. 9 was executed previously.

Furthermore, in a case where the standard speed has been changed to the low speed while the image forming apparatus is forming the tone correction patterns, the CPU 313 generates the γLUTs 307 for the low speed using the patch images formed at the standard speed and the patch images formed at the low speed. For example, in a case where the change to the low speed has occurred after the patch images corresponding to five tones with tone values of 0 to 86 have been formed at the standard speed, the CPU 313 forms the patch images with tone values of 104, 128, 176, 224, and 255 at the low speed. The CPU 313 converts the detection result of the patch images of five tones formed at the standard speed into the densities of the patch images at the low speed based on the conversion table, and generates the γLUTs 307 for the low speed from the converted densities of the patch images and the detection result of the remaining patch images of five tones formed at the low speed. In this way, in a case where the standard speed has been changed to the low speed, there is no need to form the patch images of 10 tones again at the low speed; therefore, even in a case where the process speed (image forming speed) is changed while the tone correction patterns are formed, fluctuations in the image densities can be suppressed.

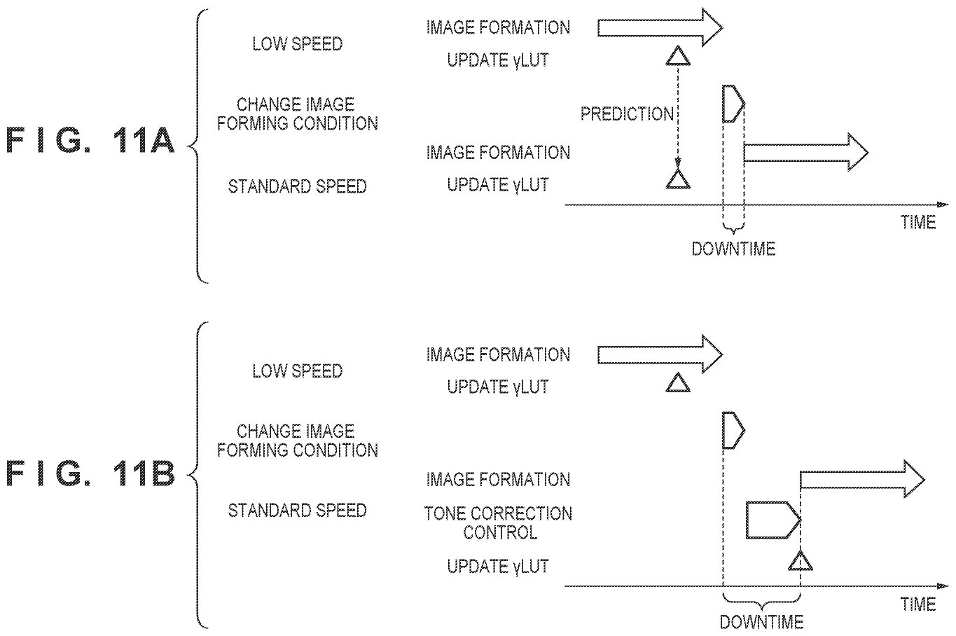

FIG. 11A and FIG. 11B are timing charts for a case where a job for forming an image at the standard speed has occurred after an image has been formed at the low speed. Note that FIG. 11A is a timing chart according to the present embodiment, whereas FIG. 11B is a timing chart according to a conventional configuration. Note, it is assumed in FIG. 11B that the standard speed is a reference process speed according to the conventional configuration. In the present embodiment, the γLUTs 307 for both of the low speed and the standard speed can be generated and updated, for example, during image formation at the low speed. Therefore, when the low speed is changed to the standard speed, image formation can be started using the updated γLUTs 307 for the standard speed after downtime for changing the image forming conditions, such as the transfer voltage. On the other hand, according to the conventional example, during image formation at the low speed, the γLUTs 307 for the low speed can be generated and updated, but the γLUTs 307 for the standard speed cannot be generated and updated. Therefore, downtime takes place after the image forming conditions, such as the transfer voltage, have been changed until the γLUTs 307 for the standard speed are updated by performing the tone correction control at the standard speed. As one example, downtime in FIG. 11A is 5 seconds, whereas downtime in FIG. 11B is 35 seconds.

As described above, the conversion table for converting the densities among process speeds is generated, and the densities at another process speed are determined, based on the conversion table, from the densities of the patch images formed on the intermediate transfer member 106 at a certain process speed. With this configuration, the γLUTs 307 for each of the plurality of process speeds can be generated and updated while an image is formed at a process speed based on a job. Therefore, downtime for generating the γLUTs 307 can be reduced.

### Second Embodiment

Subsequently, a second embodiment will be described with a focus on the differences from the first embodiment. In a case where image formation has been performed continuously, tones on a sheet 110 may fluctuate. This fluctuation is based on various factors; one of such factors is a potential fluctuation on the photosensitive members 105. The potential fluctuation on the photosensitive members 105 is caused by accumulation of residual charges on layers of the photosensitive members 105 that hold the potential, thinning of films of surface layers of the photosensitive members 105 due to the use thereof, an environment of installation thereof, and so forth. In view of this, in the present embodiment, tones are maintained by compensating the potential fluctuation on the photosensitive members 105 by way of control on the exposure intensity of the light sources 108 of the exposure units 107.

Here, even if the photosensitive members 105 are exposed to light at the same exposure intensity, the potential on exposed regions of the photosensitive members 105 can vary depending on the process speed, similarly to the first embodiment. For this reason, the present embodiment generates and updates a conversion table for converting the light emission intensity (exposure intensity) of the light sources 108, which causes the exposed regions of the photosensitive members 105 to have the same potential, among a plurality of process speeds.

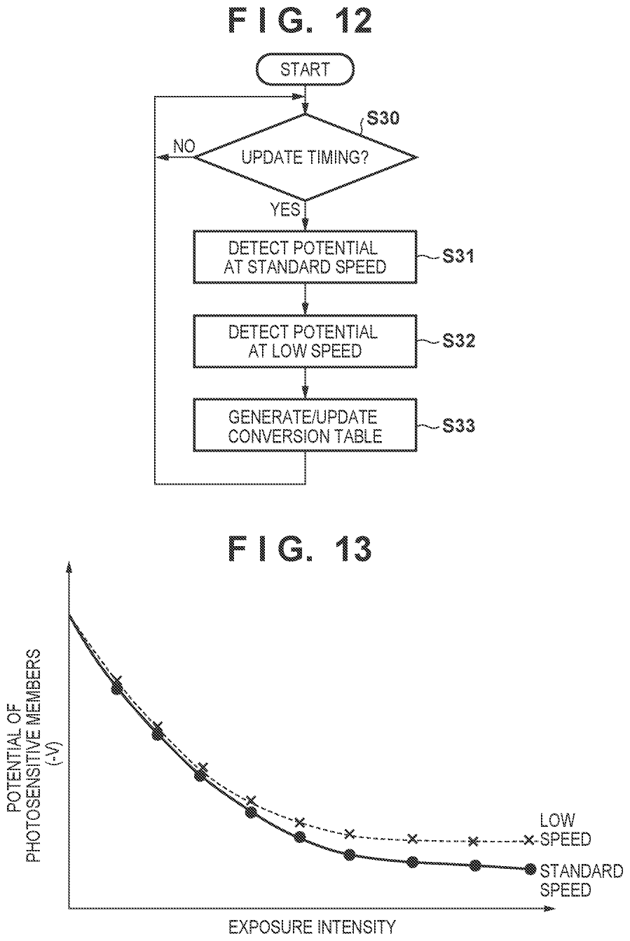

FIG. 12 is a flowchart of processing for generating or updating the conversion table according to the present embodiment. Note, it is assumed that there are two process speeds, namely the “standard speed” and the “low speed”, similarly to the first embodiment; however, the present embodiment is applicable also to the image forming apparatus 100 that has three or more process speeds. In step S30, the CPU 313 waits until the arrival of an update timing for the conversion table. The update timing for the conversion table is, for example, when the power of the image forming apparatus 100 has been turned ON, when a certain time period has elapsed without performing image formation, a timing at which environmental conditions, such as the temperature and/or humidity, have fluctuated by an amount larger than a predetermined amount, or the like. Upon arrival of the update timing for the conversion table, in step S31, the CPU 313 sets the process speed at the standard speed, exposes the photosensitive members 105 to light at each of a plurality of exposure intensities, and detects the potential on the exposed regions of the photosensitive members 105 using the potential detection units 800. In step S32, the CPU 313 sets the process speed at the low speed, and detects the potential on the exposed regions of the photosensitive members 105 using the potential detection units 800, similarly to step S31.

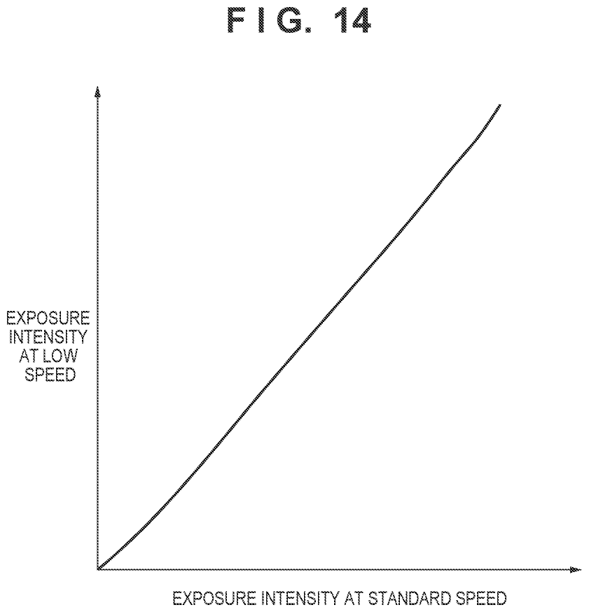

A solid line in FIG. 13 indicates an example of a relationship between the exposure intensity and the potential detected in step S31, and a dash line in FIG. 13 indicates an example of a relationship between the exposure intensity and the potential detected in step S32. FIG. 14 shows an example of the conversion table generated in step S33. The conversion table indicates a relationship between the exposure intensities at the respective process speeds that cause the photosensitive members 105 to have the same potential. Note that the same goes for a case where there are three or more process speeds.

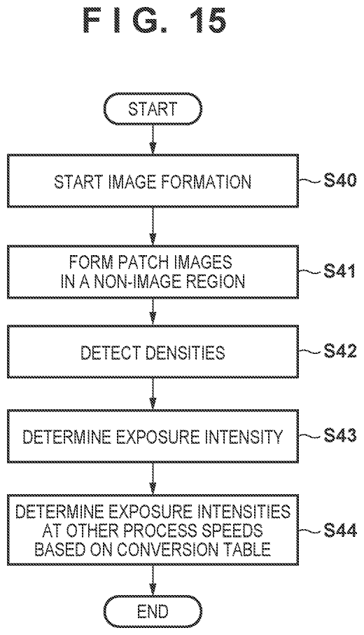

FIG. 15 is a flowchart of the tone correction control according to the present embodiment. Note that as stated earlier, the tone correction control according to the present embodiment is processing for adjusting the exposure intensity of the light sources 108. The CPU 313 executes processing of FIG. 15 when a predetermined condition is satisfied. The predetermined condition is satisfied, for example, in a case where image formation based on the first job after the power of the image forming apparatus has been turned ON has been started, or in a case where the number of printed sheets has exceeded a predetermined number since processing of FIG. 9 was executed previously. In step S40, the CPU 313 starts image formation based on a job. In step S41, the CPU 313 forms at least one patch image for exposure intensity adjustment in a non-image region of the intermediate transfer member 106. In step S42, the CPU 313 determines the density of the patch image formed in step S41 based on the detection result by the density sensor 117. In step S43, the CPU 313 determines the amount of adjustment of the exposure intensity based on the difference between a target density of the patch image for exposure intensity adjustment and the detected density of this patch image in step S42, and determines the adjusted exposure intensity based on this amount of adjustment and on the exposure intensity in step S41. In step S44, based on the exposure intensity determined in step S43, the CPU 313 determines the exposure intensities at other process speeds using the conversion table.

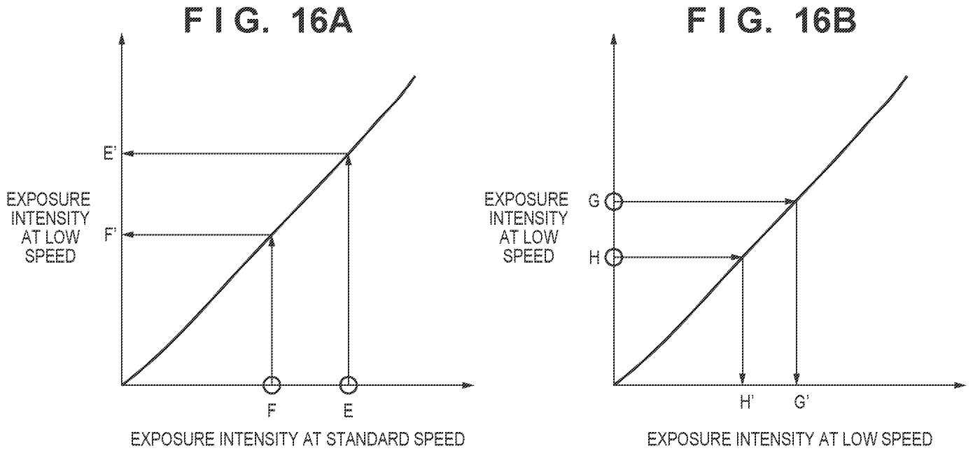

For example, as shown in FIG. 16A, in a case where the exposure intensity at the standard speed determined in step S43 is E, the CPU 313 determines that the exposure intensity at the low speed is E′ in accordance with the conversion table in step S44. Similarly, as shown in FIG. 16A, in a case where the exposure intensity at the standard speed determined in step S43 is F, the CPU 313 determines that the exposure intensity at the low speed is F′ in accordance with the conversion table in step S44. On the other hand, as shown in FIG. 16B, in a case where the exposure intensity at the low speed determined in step S43 is G, the CPU 313 determines that the exposure intensity at the standard speed is G′ in accordance with the conversion table in step S44. Similarly, as shown in FIG. 16B, in a case where the exposure intensity at the low speed determined in step S43 is H, the CPU 313 determines that the exposure intensity at the standard speed is H′ in accordance with the conversion table in step S44.

Note that the present embodiment can also be combined with the first embodiment. That is to say, the exposure intensity at each process speed can be adjusted using one patch image in the tone correction patterns of the first embodiment, and additionally, the γLUTs 307 for each process speed can be generated in a manner similar to the first embodiment. Note that the patch image used for the adjustment of the exposure intensities among the plurality of patch images that compose the tone correction patterns can be, for example, a patch image with the highest density among the plurality of patch images. Also, it is permissible to adopt a configuration in which both of the tone correction patterns and the patch image for exposure intensity adjustment are formed, and the tone correction control according to the first embodiment (the γLUTs 307 are generated) and the tone correction control according to the present embodiment (the exposure intensities are adjusted) are performed in parallel.

Furthermore, the present embodiment is based on the precondition that the charge potential on (the potential on unexposed regions of) the photosensitive members 105 applied by the primary chargers 111 is made constant, regardless of the process speed. Therefore, in the present embodiment, the conversion table indicates the relationship between the exposure intensities at the respective process speeds that cause the exposed regions of the photosensitive members 105 to have the same potential. However, in some cases, a configuration that causes the charge potential to vary depending on the process speed is adopted. In such cases, the conversion table indicates the relationship between the exposure intensities at the respective process speeds that bring about the same development contrast potential, which is the difference between the potential on the exposed regions generated by exposing the photosensitive members 105 with the charge potential to light and the development potential output from the developers 112.

As described above, according to the present embodiment, appropriate exposure intensities at the respective process speeds can be determined during image formation at a certain process speed. Therefore, similarly to the first embodiment, the extension of downtime due to the tone correction control can be prevented.

### Third Embodiment

Subsequently, a third embodiment will be described with a focus on the differences from the first embodiment and the second embodiment. In the tone correction control according to the second embodiment (FIG. 15), the exposure intensity is determined in step S43 based on the detected density of the patch image for exposure intensity adjustment. In the present embodiment, the potential on the exposed regions of the photosensitive members 105 is detected using the potential detection units 800, the amount of adjustment of the exposure intensity is determined based on the difference between the detected potential and a target potential, and the adjusted exposure intensity is determined based thereon. Therefore, in a case where the object of the tone correction control is only to adjust the exposure intensity, only the electrostatic latent images are formed on the photosensitive members 105, and there is no need to form a patch image on the intermediate transfer member 106.

Furthermore, the present embodiment can also adopt a configuration in which the generation and the update of the γLUTs 307 and the adjustment of the exposure intensity are performed in parallel, similarly to the second embodiment. In this case, similarly to the first embodiment, the CPU 313 forms tone correction patterns in a non-image region of the intermediate transfer member 106. At this time, using the potential detection units 800, the CPU 313 detects the potential on the electrostatic latent images (the exposed regions) that have been formed on the photosensitive members 105 to form a predetermined patch image in the tone correction patterns on the intermediate transfer member 106. The predetermined patch image can be a patch image with the highest tone. Then, the CPU 313 determines the exposure intensities at the respective process speeds based on the detection result by the potential detection units 800. Furthermore, the CPU 313 updates the γLUTs 307 for each process speed based on the tone correction patterns formed on the intermediate transfer member 106. Note that it is permissible to adopt a configuration in which, in a case where the exposure intensity at the process speed in the current job has been changed based on the detected potential on the exposed regions of the photosensitive members 105, the γLUTs 307 for each process speed may be generated and updated by forming the tone correction patterns on the intermediate transfer member 106 using the changed exposure intensity.

As described above, according to each of the above-described embodiments, a conversion table for converting a tone correction condition at a certain process speed into another tone correction condition at another process speed is generated in advance. Or a conversion table for converting a detection value related to a test image formed at a certain process speed into another detection value related to another test image formed at another process speed is generated in advance. Note that a detection value corresponds to, for example, a density of a patch image in the first embodiment. With use of the conversion table, a tone correction condition at each process speed can be generated and updated by way of tone correction control at a certain process speed, thereby reducing downtime due to the tone correction control. Note that the conversion table is generated, for example, when the image forming apparatus has been started up, or when the image forming apparatus has executed a return operation for forming an image after it has been left without executing an image forming operation for a long period of time.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-093096, filed Jun. 8, 2022, which is hereby incorporated by reference herein in its entirety.

What is claimed is:

1. An image forming apparatus that forms an image on a sheet using a tone correction condition corresponding to a process speed, the image forming apparatus comprising:
an image forming unit configured to form an image on an image carrier;
a first detection unit configured to detect a density of the image formed on the image carrier;
a storage unit configured to store first conversion information for converting the density of the image formed on the image carrier by the image forming unit into a density at a process speed that is different from a process speed at the time of formation of the image among a plurality of process speeds; and
a control unit configured to
while the image is formed on the sheet in accordance with a print job, form a plurality of first patch images of different densities on the image carrier by controlling the image forming unit,
with respect to each of the plurality of process speeds, determine respective densities of the plurality of first patch images based on respective densities of the plurality of first patch images detected by the first detection unit, a process speed at the time of formation of each of the plurality of first patch images, and the first conversion information, and
generate pieces of the tone correction condition that respectively correspond to the plurality of process speeds based on the respective densities of the plurality of first patch images that have been determined with respect to each of the plurality of process speeds.

2. The image forming apparatus according to claim 1, wherein
the control unit is further configured to form a plurality of second patch images on the image carrier at each of the plurality of process speeds, and generate the first conversion information based on densities of the plurality of second patch images that have been detected by the first detection unit at each of the plurality of process speeds.

3. The image forming apparatus according to claim 1, wherein
the tone correction condition includes information for converting a tone value of image data that has been input for the print job.

4. The image forming apparatus according to claim 1, wherein
the image forming unit includes: a photosensitive member; a charging unit configured to charge the photosensitive member; an exposure unit configured to form an electrostatic latent image on the photosensitive member by exposing the charged photosensitive member to light; and a development unit configured to form the image on the photosensitive member by developing the electrostatic latent image, and
the image carrier is the photosensitive member.

5. The image forming apparatus according to claim 1, wherein
the image forming unit includes: a photosensitive member; a charging unit configured to charge the photosensitive member; an exposure unit configured to form an electrostatic latent image on the photosensitive member by exposing the charged photosensitive member to light; a development unit configured to form the image on the photosensitive member by developing the electrostatic latent image; and a transfer unit configured to transfer the image formed on the photosensitive member to the image carrier.

6. The image forming apparatus according to claim 4, wherein
the tone correction condition includes an exposure intensity of the exposure unit,
the storage unit is configured to further store second conversion information indicating a relationship among the exposure intensities at the plurality of process speeds with which a difference between a potential on an exposed region of the photosensitive member exposed by the exposure unit and a development potential of the development unit becomes the same, and
the control unit is configured to: determine a first exposure intensity used at a first process speed at the time of formation of one first patch image among the plurality of first patch images by adjusting the exposure intensity at the time of formation of the one first patch image based on a difference between a density of the one first patch image detected by the first detection unit and a target density of the one first patch image; and determine a second exposure intensity used at a second process speed among the plurality of process speeds based on the first exposure intensity and the second conversion information, the second process speed being different from the first process speed.

7. The image forming apparatus according to claim 6, further comprising:
a second detection unit configured to detect a potential on a surface of the photosensitive member,
wherein the control unit is configured to: expose the photosensitive member to light at each of a plurality of exposure intensities by controlling the exposure unit with respect to each of the plurality of process speeds; using the second detection unit, detect a potential on the surface of the photosensitive member when the photosensitive member has been exposed to light at each of the plurality of exposure intensities; and generate the second conversion information by determining a relationship between the exposure intensity and the potential on the surface of the photosensitive member with respect to each of the plurality of process speeds.

8. The image forming apparatus according to claim 6, wherein
the one first patch image is a first patch image with a highest density among the plurality of first patch images.

9. The image forming apparatus according to claim 4, further comprising:
a second detection unit configured to detect a potential on a surface of the photosensitive member,
wherein
the tone correction condition includes an exposure intensity of the exposure unit,
the storage unit is configured to further store second conversion information indicating a relationship among the exposure intensities at the plurality of process speeds with which a difference between a potential on an exposed region of the photosensitive member exposed by the exposure unit and a development potential of the development unit becomes the same, and
the control unit is configured to: determine a first exposure intensity used at a first process speed at the time of formation of a first electrostatic latent image by adjusting the exposure intensity at the time of formation of the first electrostatic latent image based on a difference between a potential detected by the second detection unit on the first electrostatic latent image and a target potential of the first electrostatic latent image, the first electrostatic latent image having been formed on the photosensitive member to form one first patch image among the plurality of first patch images; and determine a second exposure intensity used at a second process speed among the plurality of process speeds based on the first exposure intensity and the second conversion information, the second process speed being different from the first process speed.

10. The image forming apparatus according to claim 9, wherein
the control unit is configured to: expose the photosensitive member to light at each of a plurality of exposure intensities by controlling the exposure unit with respect to each of the plurality of process speeds; using the second detection unit, detect a potential on the surface of the photosensitive member when the photosensitive member has been exposed to light at each of the plurality of exposure intensities; and generate the second conversion information by determining a relationship between the exposure intensity and the potential on the surface of the photosensitive member with respect to each of the plurality of process speeds.

11. An image forming apparatus that forms an image on a sheet using a tone correction condition corresponding to a process speed, the image forming apparatus comprising:
an image forming unit that includes a photosensitive member, a charging unit configured to charge the photosensitive member, an exposure unit configured to form an electrostatic latent image on the photosensitive member by exposing the charged photosensitive member to light at an exposure intensity indicated by the tone correction condition, a development unit configured to form the image on the photosensitive member by developing the electrostatic latent image, and a transfer unit configured to transfer the image formed on the photosensitive member to a sheet either directly or via the image carrier;
a detection unit configured to detect a density of the image formed on the image carrier or the photosensitive member;
a storage unit configured to store conversion information indicating a relationship among the exposure intensities at a plurality of process speeds with which a difference between a potential on an exposed region of the photosensitive member exposed by the exposure unit and a development potential of the development unit becomes the same; and
a control unit configured to
while the image is formed on the sheet in accordance with a print job, form a patch image on the image carrier or the photosensitive member by controlling the image forming unit, and
determine a first exposure intensity used at a first process speed at the time of formation of the patch image by adjusting the exposure intensity at the time of formation of the patch image based on a difference between a density of the patch image detected by the detection unit and a target density of the patch image, and determine a second exposure intensity used at a second process speed among the plurality of process speeds based on the first exposure intensity and the conversion information, the second process speed being different from the first process speed.

12. An image forming apparatus that forms an image on a sheet using a tone correction condition corresponding to a process speed, the image forming apparatus comprising:
an image forming unit that includes a photosensitive member, a charging unit configured to charge the photosensitive member, an exposure unit configured to form an electrostatic latent image on the photosensitive member by exposing the charged photosensitive member to light at an exposure intensity indicated by the tone correction condition, a development unit configured to form the image on the photosensitive member by developing the electrostatic latent image, and a transfer unit configured to transfer the image formed on the photosensitive member to a sheet either directly or via the image carrier;
a storage unit configured to store conversion information indicating a relationship among the exposure intensities at a plurality of process speeds with which a difference between a potential on an exposed region of the photosensitive member exposed by the exposure unit and a development potential of the development unit becomes the same;
a detection unit configured to detect a potential on a surface of the photosensitive member; and
a control unit configured to
form a first exposed region on the photosensitive member by exposing the photosensitive member to light by way of control on the image forming unit while the image is formed on the sheet in accordance with a print job, and
determine a first exposure intensity used at a first process speed at the time of formation of the first exposed region by adjusting the exposure intensity at the time of formation of the first exposed region based on a difference between a potential on the first exposed region detected by the detection unit and a target potential of the first exposed region, and determine a second exposure intensity used at a second process speed among the plurality of process speeds based on the first exposure intensity and the conversion information, the second process speed being different from the first process speed.
